(19) United States
(12) Patent Application Publication
(10) Pub. No.: US 2012/0040142 A1
(43) Pub. Date: Feb. 16, 2012

(54) ARC-SHAPED BENT GLASS OR GLASS-CERAMIC MOLDED PART AND PRODUCTION METHOD

(76) Inventors: Oliver Muehlke, Geisenheim (DE); Frank Krumpholtz, Uelversheim (DE)

(21) Appl. No.: 13/209,904

(22) Filed: Aug. 15, 2011

(30) Foreign Application Priority Data
Aug. 16, 2010 (DE) 102010036999.3-45

(51) Int. Cl. C03B 23/023; B32B 17/00; C03B 23/025

(52) U.S. Cl. 428/174; 65/107; 65/60.1

(57) ABSTRACT

A method for the production of an arc-shaped glass or glass-ceramic molded part is provided, whereby a green glass blank is brought to a temperature state in which its viscosity makes forming possible and the green glass blank is pressed onto shaped on an arc-shaped supporting surface of a mold by at least one moveable lower holder so as to produce a glass or glass-ceramic molded part with an arc-shaped region that spans an angle greater than 180°.

### CROSS REFERENCE TO RELATED APPLICATIONS

This application claims benefit under 35 U.S.C. §119(a) of German Patent Application No. 10 2010 036 999.3-45, filed Aug. 16, 2010, the entire contents of which are incorporated herein by reference.

### BACKGROUND OF THE INVENTION

1. Field of the Invention

The invention relates to a glass or glass-ceramic molded part that has an arc-shaped bent component region. In addition, the invention relates to a method for the production of an arc-shaped bent glass or glass-ceramic molded part, whereby a green glass blank is brought to a temperature state in which its viscosity makes it possible to shape it, and whereby the green glass blank is shaped on an arc-shaped supporting surface of a mold.

2. Description of Related Art

A method for the production of such a glass-ceramic molded part is known from DE 101 02 576 A1. In this case, a mold is used that has a cavity-shaped uptake region. A green glass blank is positioned over the uptake region and is converted into a plastic state under the effect of temperature, so that the green glass sinks into the cavity. The glass material is thereby applied to the wall of the cavity. Subsequently, the green glass material is ceramicized at a further increased temperature level. After a cooling phase, the three-dimensional, formed and arc-shaped bent glass-ceramic molded part can be removed from the mold. Frequently, arc-shaped bent glass-ceramic molded parts are required that span an arc region greater than 180°. However, since only arc regions smaller than or equal to 180° can be produced with the gravity sinking known from DE 101 02 576 A1, two or more glass or glass-ceramic molded parts must be fabricated and then are combined in the final product. This requires a higher expenditure for frame construction and the product is not seen as optically appealing as a one-piece glass part without discontinuities.

Methods in which glass or glass-ceramic molded parts that span an arc region greater than 180° can be produced are also known from the prior art. For this purpose, first of all, a glass tube is fabricated, as is described, for example, in DE 10 2005 031 657 A1. The desired segment arc is subsequently cut out from the glass tube. In the case of a glass ceramic, a ceramicizing step additionally takes place before or after cutting the tube. The cutting of an arc segment from a tube is very complicated and is not possible with standard glass processing machines, based on the three-dimensional shape of the glass tube. Also, the subsequent edge processing requires a clearly increased expenditure in comparison to the processing of flat glass. If the ceramicizing takes place prior to the cutting of the tube to the final format—which facilitates the ceramicizing step, since a tube can be ceramicized while standing, without complicated supporting structures—this has the disadvantage that the glassy layer that is formed on the entire surface by the ceramicizing is discontinuous at all processing sites. The glassy layer has the advantage that the surface has a significantly increased resistance against chemical attack, particularly against glass corrosion. However, the mechanical strength is reduced by an edge processing that is conducted after the ceramicizing, since an eliminating of microcracks in the processed edges, which is initiated by the ceramicizing, no longer occurs.

If the ceramicizing occurs after the edge processing, a uniform, glassy layer is formed on the entire surface, but now the glass part needs to be supported by an appropriate device during the ceramicizing process. Without support, the component would have to be discarded due to the low viscosities obtained during the ceramicizing process.

### BRIEF SUMMARY OF THE INVENTION

A method is provided in which arc-shaped bent glass or glass-ceramic molded parts can be produced in a simple way.

Glass or glass-ceramic molded parts are also provided that can be produced with the method according to the invention and that has good stability and user properties.

The method includes bending the green glass blank around the supporting surface during the forming process by means of at least one movable lower holder.

According to the invention, the green glass blank is thus first of all converted to a formable state and then forced by the lower holder onto the supporting surface of the mold. In this way, glass or glass-ceramic molded parts can be produced that are executed with an arc region greater than 180°. In this way, a homogeneous glass thickness particularly can be produced in the entire component without problem, as a function of the glass blank used, since the lower holder, due to its mobility, continuously forms the green glass blank on the supporting surface of the mold. Since the green glass blank experiences no change or only an unessential change with respect to its glass thickness during the forming process, a homogeneous transmission is also formed in the entire component. In addition, the shaped glass-ceramic molded part is characterized essentially by a homogeneous surface property, dependent on the surface quality of the glass blank that is used.

According to a preferred variant of the invention, it can be provided that the lower holder is moved along the arc-shaped supporting surface during the forming process, whereby the green glass blank is formed in the region between the lower holder and the supporting surface. Since the lower holder follows the supporting surface at a short distance, the same other bending conditions are reached over the entire bending process. This particularly also leads to homogeneous forming, without effects on the thickness course and the surface quality of the glass or glass-ceramic molded part.

In order to optimize the molding process, it can be provided that the green glass blank is formed by at least two opposite-running lower holders. In this way, it is achieved that the two lower holders hold the green glass blank in position via their opposite-running movement and thus additional lower holders for positioning can optionally be dispensed with.

In order to keep the surface of the glass or glass-ceramic molded part as undamaged or as uninfluenced as possible, it may be provided according to a variant of the method of the invention that the lower holder is rolled onto the green glass blank by means of one or more rollers.

The green glass blank can be ceramicized after forming has occurred. In this case, it has proven particularly advantageous, if the lower holder is moved into a final forming position, in which it is applied onto the formed green glass blank, and that the lower holder is held in the final forming position during the ceramicizing and cooling phases of the glass and glass-ceramic molded part that has been shaped from the glass blank. In this way, a plastic return of the formed component to its initial shape is prevented, as long as a sufficiently low solidification temperature or a sufficiently high viscosity has been obtained.

In order to simplify the molding tool, all molding movements and molding forces are produced by the gravitational force of the individual components. This avoids the use of additional drive and control technology and makes possible its use in commercial continuous furnaces. Molding forces and other process parameters can be adjusted by variation of points of rotation and weights of the components. The tool begins the molding of the glass blank as soon as the viscosity of this blank is low enough to allow its forming. This also makes possible the forming of currently common high-performance glass ceramics having high contents of nucleating agents, which provide only a brief time window with low viscosity sufficient for forming during the thermal ceramicizing process.

A particularly preferred conducting of the method according to the invention is designed so that before it is molded, the green glass blank is provided with a decorative coating and/or a functional coating and/or is mechanically processed or machined. This decorative or functional coating is not adversely affected during the molding process. For example, IR-reflecting layers, reflecting layers, anti-reflecting layers, etc. can be introduced as functional coatings. For decorative coatings, it is conceivable to introduce ceramic colors onto the glass blank. Since the glass blank is present in its initial state as a flat component, such coating is particularly simple to carry out. The thermal process for the molding then serves simultaneously for burning in the decoration.

As mechanical processing, for example, an edge grinding, in particular a faceting or an introduction of openings or break-outs is conceivable. After the ceramicizing, the machined regions as well as the adjacent surface regions have a uniform, glassy layer.

The invention relating to the glass or glass-ceramic molded part is solved in that the glass or glass-ceramic molded part has a component region formed in an arc shape, wherein the arc-shaped bent component region extends over an arc region greater than 180°, wherein one or more edges of the glass or glass-ceramic molded part has (have) a machined edge geometry, at least in regions, and/or wherein the glass or glass-ceramic molded part has one or more edges that bound an opening or a recess, and wherein the glass-ceramic molded part has a glassy zone on the machined edges.

This glass or glass-ceramic molded part can be manufactured from a green glass blank, in which recesses, openings, for example boreholes, or the like, may have already been incorporated in its initial state. In addition, the edges of the green glass blank can be processed and in particular, can be provided with a facet grinding. These processing steps can be simply conducted on the glass blank. The processed edge regions now have the same strength properties in the formed and optionally ceramicized molded part as the adjacent surface regions, since the molding is conducted as the final method step. In particular, in contrast to conventional glass-ceramic molded parts, in which the edge processing is conducted afterward, there is no damage to the glassy zone in the edge region. This leads to a higher breaking strength of the fabricated glass-ceramic molded part. Also, any possible damage such as microcracks, which have been introduced in the edge region during the mechanical processing of the green glass blank, can be eliminated during the thermal process. Finally, the glass-ceramic molded part is also characterized by a good chemical stability, for example, relative to glass corrosion, since all edge regions have the same glassy layer as the adjacent, unprocessed surface regions.

According to the invention, it may be provided that the arc-shaped bent component region is formed cylindrically, or elliptically, or similarly. Also, asymmetrical forms, such as, for example, a spiral or helical shape can be presented.

It has been shown that a particularly reliable production process with equally good other component qualities can be achieved, if the arc-shaped component region has a diameter of 300 mm to 1000 mm. More preferably, the arc-shaped component region has an arc region>180° to <360°, whereby an arc region of ≧210° to ≦330° is particularly preferably produced.

An especially good processability, as well as an especially good component quality relative to geometrical deviations and surface quality are then achieved, if the wall thickness of the glass or glass-ceramic molded part is greater than 2 mm and preferably is selected in the range between 2 mm and 8 mm. Depending on the diameter of the component, an approximately equal surface quality is obtained in this thickness region of 2 mm to 8 mm with a bending about the neutral fiber of the glass material in the tensile range and in the pressure range, since the relative extension on the tensile side or compression on the pressure side can be neglected.

The obtainable fluctuations in thickness are dependent on the thickness fluctuations of the planar glass blank and are not influenced by the molding process. There is another advantage here, since in comparison to manufacture of tubes, in the production of flat glass, in general, narrower tolerances can be produced relative to thickness fluctuation.

Also, the surface quality of the initial material is not influenced by the method. Surface structures that can be introduced, for example, by rolling in the production of flat glass, can also be prepared in this way.

### BRIEF DESCRIPTION OF THE SEVERAL VIEWS OF THE DRAWINGS

The invention will be explained in further detail in the following on the basis of an example of embodiment shown in the drawings.

FIGS. 1 to 3 show a molding process in schematic representation, and

FIG. 4 shows a three-dimensionally formed glass-ceramic molded part.

### DETAILED DESCRIPTION OF THE INVENTION

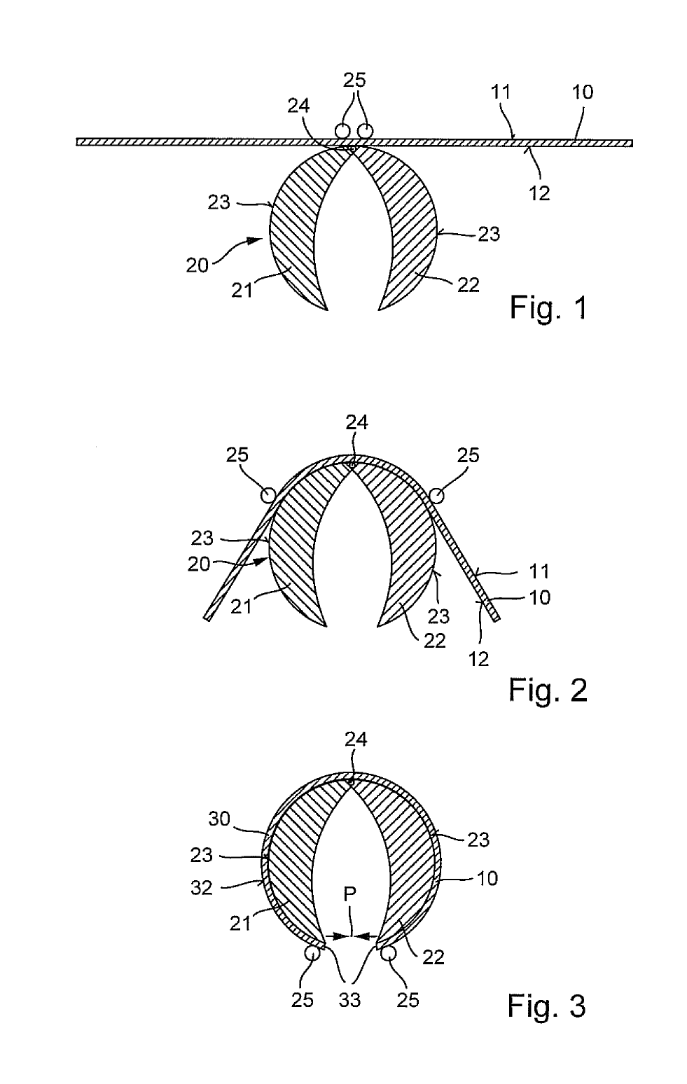

FIG. 1 shows a mold 20, which has two mold parts 21 and 22 that can move opposite one another. The two supporting pieces 21 and 22 are coupled here by a moveable connection 24. Preferably, the moveable connection is formed by a hinge with a pivoting axis. The two supporting pieces 21 and 22 each have an arc-shaped supporting surface 23, whereby the two supporting surfaces 23 create a common partial cylinder surface. A rectangular or square green glass blank 10 is placed in the region of the moveable connection 24. Other profile forms for the green glass blank 10 are also conceivable. The green glass blank 10 is placed with its underside 12 onto supporting pieces 21 and 22. Two lower holders 25 act on this upper side 11 of the green glass blank 10. These hold the green glass blank 10 on the supporting surfaces 23. In a subsequent method step, the green glass blank 10 is heated to a temperature at which it is present in a viscous state, in which a forming can be conducted. For example, a green glass, which can be referred to by the designation “Robax” by the Applicant, can be formed at temperatures above 700° C. If the green glass blank 10 is present at this temperature level, the two lower holders 25 begin to shape the glass around the supporting surfaces 23. The viscosity of the glass and the molding force of the lower holders thus determine the rate of molding. The lower holders 25 are equipped with rollers that roll on the upper side 11 of the green glass blank 10, in order to avoid damaging the surface.

As can be recognized in FIG. 2, the green glass blank 10 is bent around the supporting surfaces 23, whereby the lower holders 25 shape it on the supporting surfaces 23. The forming is then completed for the present when the lower holders 25 have reached the position shown in FIG. 3. Then the green glass blank 10 is shaped into a cylindrical molded part. Subsequently, the temperature level is raised to a temperature region that lies below the ceramicizing temperature of the green glass material that is used. When Robax glass is used, this temperature range lies between 760° C. and 800° C. In this temperature range, the formed green glass unit is held for a long enough time, so that any surface unevenness caused by the forming is equilibrated, which leads to an improved surface quality. Subsequently, the temperature is raised to a ceramicizing temperature (over 800° C. for Robax). After the ceramicizing has been completed, the temperature is reduced until the fabricated glass-ceramic molded part 30 is solidified. The glass-ceramic molded part 30 now lies by its inner wall 12 on the supporting surfaces 23, as is shown in FIG. 3. The lower holders 25 have been kept in the final forming position shown in FIG. 3 up to this method step, in order to prevent a plastic return of the formed unit to its initial shape. In order to be able to remove the glass-ceramic molded part 30 from the mold 20, the two supporting pieces 21, 22 are now pivoted radially inward by the movable connection 24, which pivoting is symbolized by the double arrow P. In this way, the supporting surfaces 23 are pivoted away from the inner wall 12. The glass or glass-ceramic molded part 30 can now be easily removed. Subsequently, the two supporting pieces 21, 22 are again reset in the direction opposite the double arrow P shown in FIG. 3. The lower holders 25 are brought back into their initial position shown in FIG. 1, so that a new green glass blank 10 can be assigned to mold 20.

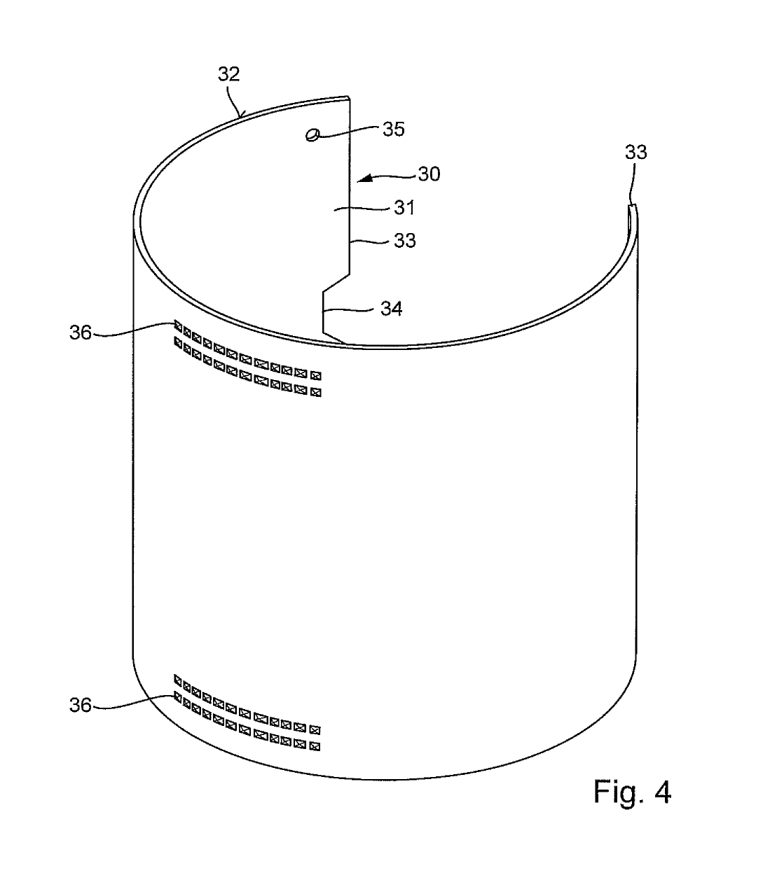

In FIG. 4, a glass or glass-ceramic molded part 30 is more closely shown in a perspective front view in FIG. 4. As can be seen in this representation, the glass or glass-ceramic molded part 30 has a cylindrically shaped component region, which extends over an arc region of approximately 270°. This glass or glass-ceramic molded part 30 was fabricated from a green glass blank 10 with rectangular geometry by the method according to FIGS. 1 to 3. In this case, the green glass blank 10 had boundary edges 33 from which a recess 34 was removed laterally. Also, openings, i.e., boreholes 35 were introduced in the flat green glass blank 10. Finally, the green glass blank 10 has also been provided with a decorative coating 36. This green glass blank 10 has now been shaped according to FIGS. 1 to 3, and ceramicized in the case of a glass ceramic, so that the unit shown in FIG. 4 has been obtained as a glass or glass-ceramic molded part 30. In this case, the recesses 34 are disposed in the region of the open arc and bound the latter.

What is claimed is:

1. A method for the production of an arc-shaped bent glass or glass-ceramic molded part, comprising:
bringing a green glass blank to a temperature in which the green glass blank has a desired viscosity; and
moving at least one moveable lower holder to shape the green glass blank on an arc-shaped supporting surface of a mold to form the molded part.

2. The method according to claim 1, wherein the at least one moveable lower holder is moved along the arc-shaped supporting surface whereby the green glass blank is formed between the at least one moveable lower holder and the arc-shaped supporting surface.

3. The method according to claim 2, wherein the at least one moveable lower holder comprises at least two opposite-running lower holders.

4. The method according to claim 2, wherein the step of moving at least one moveable lower holder comprises rolling the least one moveable lower holder on the green glass blank.

5. The method according to claim 1, further comprising ceramicizing the molded part.

6. The method according to claim 1, further comprising leaving the at least one moveable lower holder on the molded part while cooling the molded part.

7. The method according to claim 1, further comprising applying a decorative coating and/or a functional coating to the green glass blank prior to the moving step.

8. A glass or glass-ceramic molded part, comprising:
an arc-shaped bent component region, wherein the arc-shaped component region extends over an arc region greater than 180°; and
one or more edges having a processed or machined edge, at least in regions, with a glassy zone, wherein at least one edge of the one or more edges bounds an opening or a recess.

9. The glass or glass-ceramic molded part according to claim 8, wherein the arc-shaped component region has a cylindrical form or an elliptical form.

10. The glass or glass-ceramic molded part according to claim 9, wherein the arc-shaped component region has a diameter of 300 mm to 1000 mm.

11. The glass or glass-ceramic molded part according to claim 8, wherein the arc-shaped component region spans an arc region of greater than 180° and less than 360°.

12. The glass or glass-ceramic molded part according to claim 8, further comprising a wall thickness that is greater than or equal to 2 mm.

13. A method for the production of an arc-shaped bent glass or glass-ceramic molded part, comprising:
providing two supporting pieces coupled to one another by a moveable connection, the two supporting pieces forming a partial cylindrical surface;
placing an underside of a green glass blank onto the partial cylinderical surface in a region of the moveable connection;
bringing the green glass blank to a temperature in which the green glass blank has a viscous state; and
rolling the two rollers over an upper side of the green glass blank so that one of the two rollers shapes a first part of the green glass blank over one of the two supporting pieces in a first direction and another of the two rollers shapes a second part of the green glass blank over another of the two supporting pieces in an opposite direction to form the molded part.

14. The method according to claim 13, further comprising holding the molded part on the two supporting pieces by the two rollers while reducing the temperature of the molded part until solidified.

15. The method according to claim 14, further comprising moving the two supporting pieces radially inward at the movable connection so that the partial cylindrical surface is pivoted away from the underside of the molded part after being solidified.

16. The method according to claim 14, wherein before the holding step the method further comprises heating the molded part, while held on the two supporting pieces by the two rollers, to a temperature below a ceramicizing temperature of the green glass blank.

17. The method according to claim 16, further comprising holding the molded part at the temperature below the ceramicizing temperature for a sufficient time so that surface unevenness is equilibrated.

18. The method according to claim 17, further comprising heating the molded part to the ceramicizing temperature to form a ceramicized molded part.
